(19) United States
(12) Patent Application Publication
(10) Pub. No.: US 2023/0330775 A1
(43) Pub. Date: Oct. 19, 2023

(54) ROBOTIC LASER

(71) Applicants: IPG PHOTONICS CORPORATION, Marlborough, MA (US); IPG LASER GmbH, Burbach (DE)

(72) Inventors: Frank M SEIDEL, Burbach (DE); Paul SCHMOCK, Burbach (DE); Thomas MANSKE, Burbach (DE); Thomas PERTLER, Burbach (DE)

(73) Assignee: IPG PHOTONICS CORPORATION, Marlborough, MA (US)

(21) Appl. No.: 18/028,068

(22) PCT Filed: Dec. 30, 2020
(86) PCT No.: PCT/EP20/88046

§ 371 Date: Mar. 23, 2023

Related U.S. Application Data
(60) Provisional application No. 63/084,737, filed on Sep. 29, 2020.

(51) Int. Cl. B23K 26/08; B25J 11/00; B25J 17/02

(52) U.S. Cl. CPC B23K 26/0884; B25J 11/005; B25J 17/0258

(57) ABSTRACT

A multi-axis robot includes multiple arms. The last arm which is closest to the workpiece has a tip or wrist which is configured to receive an end-of-arm tooling (EOAT) rotatable about the 6^{th} axis of the robot. A mount for supporting a laser head assembly is coupled to the wrist so that the laser head assembly is not rotatable about the 6^{th} axis of the robot.

### BACKGROUND OF DISCLOSURE

### Field of the Disclosure

The disclosure relates to laser head-equipped robots. More particular, the disclosure relates to a multi-axis robot with an improved mount configured to prevent displacement of a laser head about the last axis of the multi-axis robot, for example about the sixth axis of the 6-axis robot.

### Background of the Disclosure

The new World Robotics 2020 Industrial Robots report shows a record of 2.7 million industrial robot operating in factories around the world. The industrial robot arm is the part that positions the end effector. With the robot arm, the shoulder, elbow, and processing arm move and twist to position the end effector in the exact right spot. Each of these joints gives the robot another degree of freedom, as explained immediately below.

Lasers and robots are natural partners with robots commonly serving to guide lasers in welding, cutting, marking and other processes. Advantageously, the robot has an open architecture, allowing for companies to design their own plugins and software modules to speed up interfacing between the robot and the laser system and allow customization directly on the robot pendant. In a laser-processing automated process, as a rule, a laser source is located at a distance from the robotic arm. However, a laser head—a combination of beam-guiding/beam-shaping optical components which are assembled together in a single enclosure—is mounted on the distal end of a robotic forearm and is a part of the dress package or end-of-arm tooling (EOAT) of a laser-equipped robot. The EOAT is a combination of robotic accessories often referred to as end effectors attached to the robot flange that serves a function. This includes, without limitation, a laser head, tool changer, force/torque sensing systems collision sensors, gas nozzles, scanners, and, of course, multiple electric, gas and optical cable delivering respective media to the designated end effectors.

For example, FIG. t illustrates a typical six (6)-axis industrial robot 10 which includes a base 12 supporting a first arm 14 which along with the rest of robot 10 revolves about the first (1) axis relative to base 12. The first arm 14 is also configured to move back and forth, i.e. pivot about the second (2) axis. The distal end of first arm 14 supports a lower or second arm 16 which swivels about the third (3) axis so that second arm 16 moves e.g. up and down. The second arm 16, in turn, is connected to a third arm 18 operative to rotate about the fourth (4) axis which extends perpendicular to the 3rd axis. Mounted to the distal end of the/third arm 16 is a last fourth arm 20 rotatable about the fifth (5) axis. The fourth (4^{th}) arm 20 has a flange supporting EOAT 25 which rotates about the sixth or last (6) axis. Drawing an analogy with the human anatomy, 3^{rd} arm 18 is further referred as a wrist, while 4^{th} arm 20 is mentioned as a hand.

Referring to FIG. 2 showing a novel “TruLaser Weld 5000” laser welding system manufactured by the German company TRUMPF, hand 20 may support EOAT 25 which may include a laser head itself but also any combination of the laser head, tool changer, end effectors mounted to the tool changer, cables and other components. The laser beam can be trained at any desired position within the process space. In accordance with a modern trend, the laser head, in addition to collimating and focusing optics, typically includes a scanner. The scanner may include a pair of mirrors displaceable relative to one another, as disclosed in U.S. Pat. No. 10,413,995 B2 which is incorporated herein by reference in their entirety or have an external scanner. The mirrors provide the wobble movement of the laser spot. Often, following the profile of the workpiece to be laser treated, the entire EOAT 25, including the laser head, rotates about the last axis, e.g. about the 6^{th} axis in a typical 6-axis industrial robot 10. Auxiliary tools, such as a wire feeder, gas nozzles and others necessarily rotate following the contour of the seam.

One of ordinary skill in the robotics is well aware about several disadvantages associated with the laser head's rotation about the last, e.g. the 6^{th} axis. The rotatable laser head may compromise the robot's dynamics and speed and increase the tool center control (TCP) length. The rotational movement of laser head may lead to inertia thus resulting in a robot-generated positioning error and deviation from the desired path. Furthermore, various industrial robots, including without any limitation YASKAWA (FIG. 3A), FANUC (FIG. 3B), ABB, KUKA (FIG. 3C), require large complex cable and hose bundles around the robot lower/second arm and wrist/third arm supporting the rotatable laser head. Even with the introduction of hollow-arm robots, where some cable bundles can be routed e.g. through the center of the lower/second, wrist/third and hand/forth arms, the protection of the laser head from mechanical hazards, such as undesirable whiplash motions, is still problematic. Also, the laser head adds to the footprint of EOAT 25 which can be a significant disadvantage since the work space is often too small limiting the robot's effective maneuverability. Quite often using the same robot, it is necessary to switch from a laser source to a different type of power source like an arc, drawn arc, capacitor discharge, etc. and/or replace/add one or more end effectors. For example, frequently, laser welding and brazing processes require the use of taller wire or the so-called cold wire. The high affinity of some metals, for example titanium, to the atmospheric gas oxygen hydrogen and others requires a strong gas shield. The presence of the laser head may complicate the desired replacement or reconfiguration of EOAT 25, increase machine-idle time and raise the cost of the end product.

The problems discussed above are not exclusive to 6-axis robots. Regardless of the number of axes, any robot provided with hand-like component 20, which is adapted to operate with the rotatable laser head, experiences the same problems. FIG. 3 C, illustrates an example of such a robot.

A need, therefore, exists for a multi-axis robot for operating in laser-related industrial process in which the laser head is rotationally uncoupled from the rest of the EOAT contributing thus in a compact footprint of the processing arm, minimizing a robot-generated positioning error and also allowing to increase the movement speed of the processing arm.

### SUMMARY OF THE DISCLOSURE

This need is met by a multiple-axes industrial robot which is retrofit with a laser head mounted to the hand or the last arm in accordance with the inventive concept. In particular, the inventive configuration includes a laser head mounted on the hand such that it is rotationally uncoupled from the rest of EOAT which is rotatable about last axis. Note that that the following description is exemplified by a 6-axis robot. However, the inventive concept relates to any robot provided with a rotatable laser head.

The inventive 6-axis robot is configured with first and second arms which are angularly displaceable relative to one another about the 3^{rd} axis (A₃). The second arm can be displaceable about the 4^{th} axis (A₄) relative to the first arm. The tip of the second arm is coupled to the wrist which pivots relative to the processing arm about axis A5 extending orthogonally to axis A4.

The wrist is coupled to the hand including a combination of housing, which is configured as a hollow cylinder or housing, and a hollow shaft mourned coaxially with and inside the housing and provided with a flange. The housing, pivots with arm about the 5^{th} axis, but is not rotatable about the 6^{th} or last axis. The shaft, in addition to the displacement about the 5^{th} axis, is rotatable about the 6^{th} axis. The laser head, which is mounted on the housing end coaxially with the housing and shaft, allows the laser beam to freely propagate through the shaft towards the target. In contrast to the known prior art, the laser head is not rotatable about the 6^{th} or the last axis. In other words, the laser head is rotationally uncoupled from the shaft—the configuration which provides many advantages, as discussed below.

The flange extends beyond or terminates flush with the end of the housing which is opposite to the housing end supporting the laser head. The flange is machined to receive a variety of end effectors and, thus, functions as a tool changer. The shaft, tool changer and end effectors are part of the EOAT. Ordinarily the laser head is considered to be part of the hand and, thus, rotates about the last 6^{th} axis. The inventive structure simplifies the robot's configuration by eliminating the necessity of the laser head's rotation with the shaft and providing a number of advantages associated herewith, amongst others reducing the inertness of the robot's configuration and improving the precision of the robot's movement.

The variety of end effectors are typically mounted either directly to the flange or to a plate which is coupled to the flange and configured to receive and support these effectors. Among the end effectors, one may consider the use of a variety of sensors. In addition or alternatively to the various sensors, a wire delivery mechanism alone or with various combinations of other end effectors can be detachably coupled to the plate. A gas delivery mechanism can also be mounted alone or in combination with all or some of the end effectors. The position of the laser head which is rotationally uncoupled from the rest of the MAT facilitates the robot's use with different power sources other than laser related operations. In contrast to the established practice in accordance with which the laser head is often dismounted from the robot, the inventive configuration allows the laser head to remain mounted while the retrofit robot takes part in other than laser operations. Of course, a combination of various welding techniques, such as tungsten inert gas (TIG) welding or e.g. stud welding, and laser welding only benefits from the inventive concept since there is no need to readjust the position of the laser head if any given operation does not require the laser head's use.

### BRIEF DESCRIPTION OF THE DRAWINGS

The above and other features and advantages of the disclosed robot will become more readily apparent from the specific description of the invention accompanied by the following drawings, in which:

FIG. 1 is a view of an exemplary 6-axis robot;

FIG. 2 is a view of the processing arm provided with a laser head in the known 6-axis robot;

FIGS. 3A, 3B and 3C are views of respective exemplary industrial robots frequently used in laser-related operations and designed to benefit from the current inventive configuration;

FIG. 4 is an exemplary welding system utilizing the known 6-axis robot;

FIG. 5 is an enlarged view of the 6-axis robot of FIG. 4 reconfigured in accordance with the inventive concept;

FIG. 6 is a view of the inventive robot;

FIG. 7 is a bottom view of the hand of the inventive robot of FIG. 6;

FIG. 8 is an enlarged view of the wrist/hand combination of the robot of FIG. 6;

FIGS. 9A and 9B are respective perspective and side views of the wrist/hand of FIG. 6 equipped with a laser head and sensor;

FIG. 10 is a side view of the wrist/hand of FIG. 6 provided with a laser head, sensor and cold wire delivery mechanism;

FIG. 11 is a side view of the wrist/hand of FIG. 6 provided with a laser head, sensor and gas supplying nozzle;

FIG. 12 is a side view of the wrist/hand of FIG. 6 provided with a laser head, sensor, cold wire delivery mechanism and gas nozzle;

FIG. 13 is a side view of the wrist/hand of FIG. 6 configured to provide stud welding operations;

FIG. 14A is a side view of the wrist/hand of FIG. 6 configured for a TIG operation;

FIG. 14B is a side view of the wrist/hand of FIG. 6 with the TIG and cold wire delivery mechanism;

FIG. 15A is a side view of another known robot provided with the inventive wrist; and

FIGS. 15B and 15C are respective enlarged perspective and side views of the wrist/hand of FIG. 15A.

### SPECIFIC DESCRIPTION

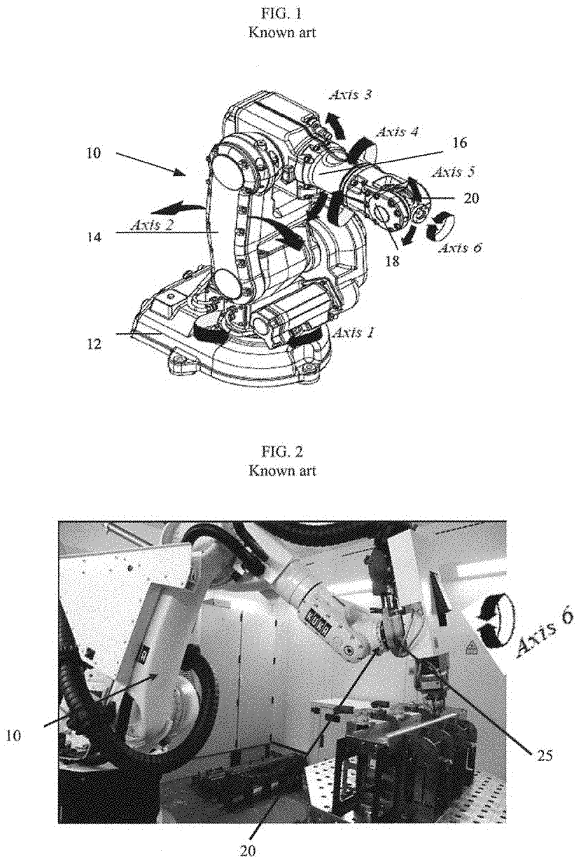

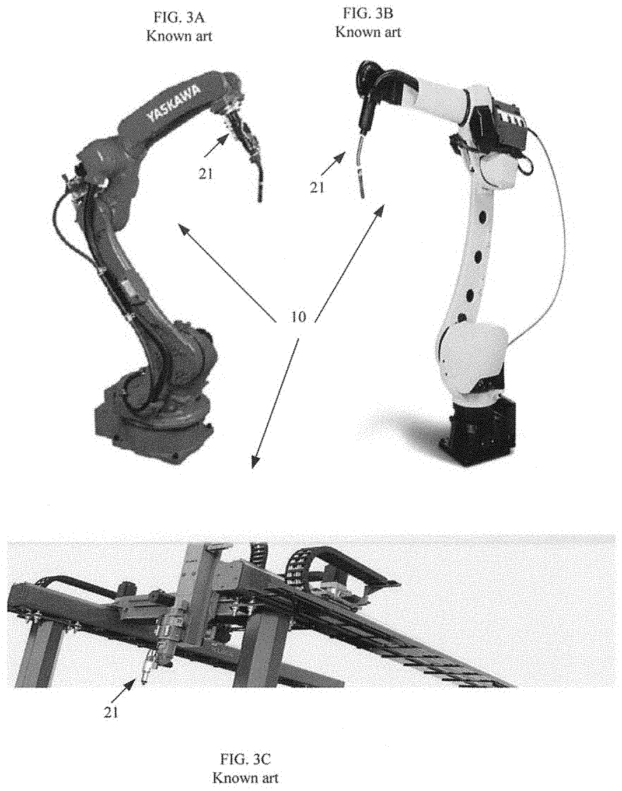

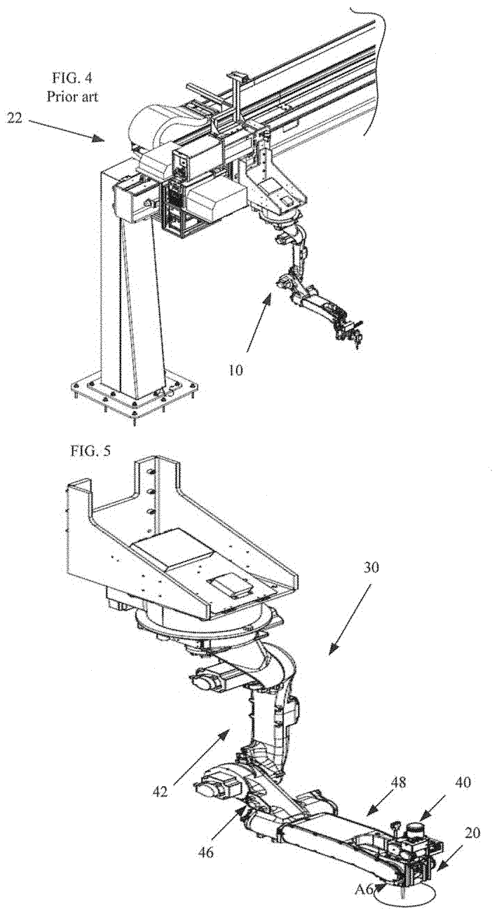

FIG. 4 illustrates a part of an exemplary system incorporating known six-axis robot 10 which is suspended on a Gantry system 22. The illustrated Gantry system 22 is utilized for assembling various object. As an example of the latter, system 22 is used to assemble the industrial kitchen equipment. However, robot 10 may be used in a variety of other operation that do not require the Gantry platform. For example, robot 10 is often used as a standalone unit, as shown in FIGS. 1, 3A, 3B and 3C.

FIG. 5 illustrates an example of the inventive multi-axis robot which, in this case, is 6-axis robot 30 which is configured similar to robot 10 of FIG. 4 and includes, among others, a first arm 42, a second or lower arm 44, a third or wrist 48 and a fourth arm or hand 20 which are coupled to one another in the known manner typical for a 6-axis robot in this example. In accordance with the inventive concept, a laser head assembly 40 is mounted on the hollow hand 20 such that the position of the laser head assembly 40 with respect to the hollow hand 20 of the robot 30 is fixed, especially in a way that it does not rotate about the last robot axis, i.e. the 6^{th} axis 6 in this example. As illustrated in FIG. 5, it is preferred that the laser head assembly 40 is mounted to the end of the hollow hand 20 which is opposite to the workpiece. In other words, the laser beam outputted by the laser head assembly 40 through the hollow hand 40 and is therefore is rotationally stationary relative the last 6^{th} axis of the robotic arm 30.

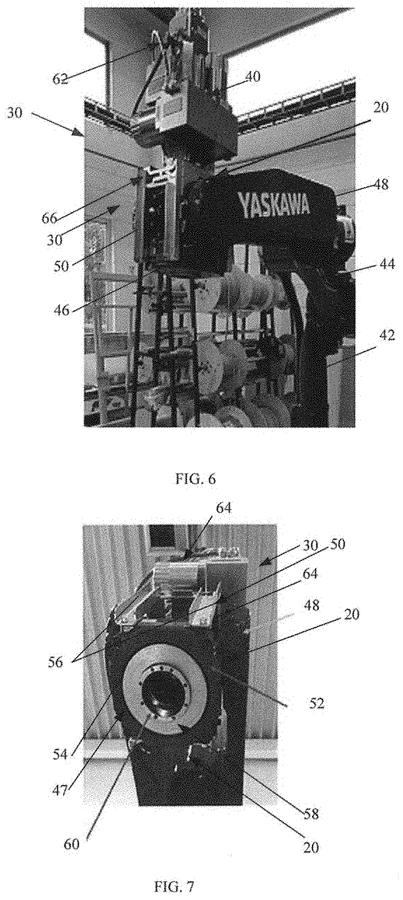

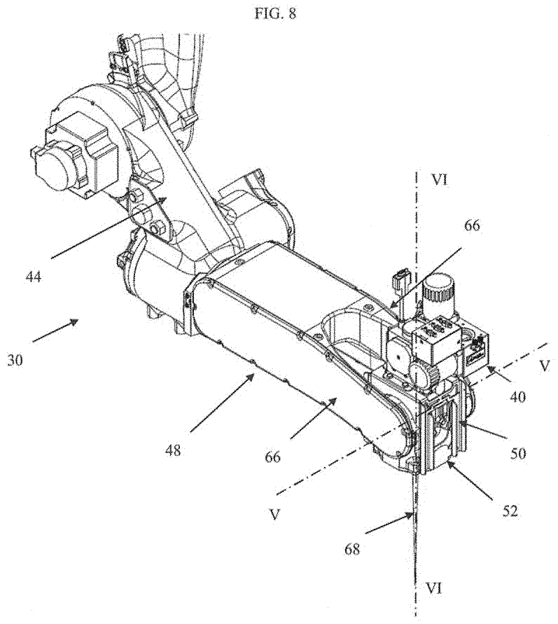

Referring to FIGS. 6 and 7, an example of the inventive concept is realized by means of a mount 50 supported on a base 52 of hand 20 which is mounted to the tip of wrist/third arm 48 and swingable about the 5^{th} axis relative to wrist 48. The base 52 is provided with a channel 54 which is shaped and dimensioned to receive a tool changer assembly 47 including a housing 58 and flanged shaft 60 of hand 20. The housing 58 and flanged shaft 60 are coaxial and centered on the last 6^{th} axis with flanged shaft 60 being rotatable about this last axis. It should be generally mentioned that the mount 50 can be implemented as a part of hollow hand 20 as well as an external element attached to hollow hand 20 or as a combination of the above alternatives.

Turning to mount 50 supporting laser head assembly 40, one of ordinary skill in the mechanical arts readily understands that its configuration is subject to limitless designs. The criticality of mount 50 includes its positioning on robot 30 so that laser head assembly 40 is rotationally uncoupled from tool changer assembly 47, i.e., the laser head assembly is stationary while tool changer 47 rotates about the last 6^{th} axis with flanged shaft 60.

In the exemplary configuration shown in FIGS. 6 and 7, mount 50 includes a frame including multiple U-shaped rails 56 extending along and straddling base 52. The rails 56, for example, can be bolted to base 52, but any other mount's structure and coupling can be utilized by one of ordinary skill subject to the reliable connection between the base and mount 50. The mount 50 has one end 66 (FIG. 6) associated with flanged shaft 60 which is coupled to tool changer 47, and the opposite end 64 (FIG. 7) supporting laser head assembly 40. Alternatively, the laser head assembly 40 can be mounted also directly to arm 20, e.g. directly screwed to it.

As better illustrated in FIG. 6, it is easy to notice how massive laser head assembly 40 can be. If mounted to the same end 66 of base 52 as tool changer assembly 47 and rotatable therewith, the laser head/tool changer assembly would be simply too cumbersome. Considering how small a workspace can be, which is rather typical, the maneuverability of robot 30 and particularly its wrist 48 would be severely limited primarily because of a large footprint of the tool changer/laser head configuration. Furthermore, even if robot 30 has a hollow arm, there still will be loose cables 62, 64, as seen in respective FIGS. 6 and 7, which include light delivery fibers, flexible pipes, hoses delivering coolant or electrical cables for sensors and other designated equipment. Certainly the loose cables do not help the maneuverability and, in fact, may be hazardous to the laser head assembly and other end effectors coupled to flange 60. The inventive structure reduces the footprint and eliminates this cable-caused hazard.

Referring to FIG. 8, wrist 48 of exemplary robot 30 has a distal split or forked tip featuring two fingers 66 which are spaced apart along the 5^{th} axis V-V and flank base 52 of hand 20 and mount 50 coupled to hand 20. The laser head assembly 40 is coupled to mount 50 such that a beam 68, which is focused on the target to be irradiated, always propagates collinear and coaxially with last taxis VI-VI on which base 52 is centered. Obviously, end 66 of mount 50 has a structure which does not interfere with beam 68 propagating along the 6^{th} axis VI-VI.

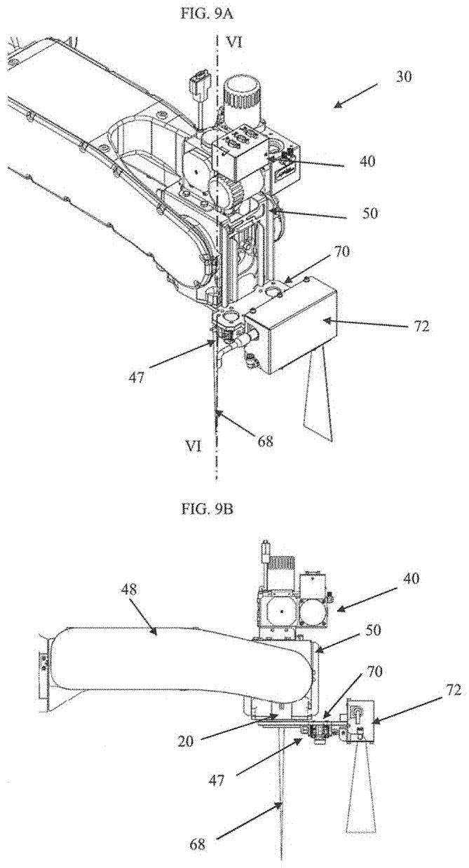

FIGS. 9A and 9B illustrate the BOAT which includes a plate 70 coupled to and rotatable with flange 60 (FIG. 7) of tool changer 47. The plate 70, in turn, provides a support for a variety of end effectors. For example, a sensor 72 is coupled to plate 70. Based on the inventive concept, while plate 70 with sensor 72 can be rotated about the 6^{th} axis VI-VI, along which beam 68 emitted from laser head assembly 40 propagates, laser head assembly 40 is mounted on mount 50 and does not rotate.

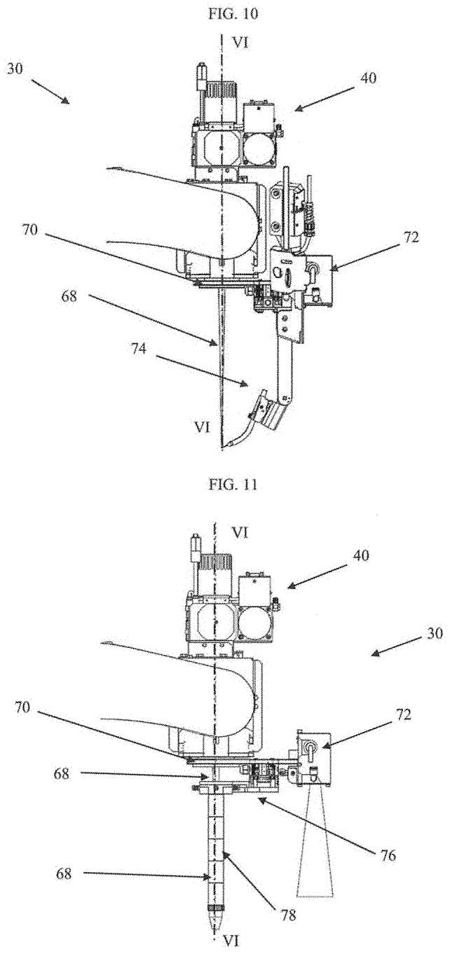

FIG. 10 illustrates additional end effectors coupled to plate 70 so as to rotate about the 6^{th} axis VI-VI. In particular, a cold wire deliver mechanism 74 is supported by plate 70 such that the wire is delivered to a weld region irradiated by beam 68. The cold wire is often required in laser welding or brazing. As shown here, plate 70 supports both sensor 72 and wire delivery mechanism 74, but because all end effectors are easily dismountable, any individual end effector can be quickly removed from or added to plate 70.

FIG. 11 illustrates another combination of end effectors. Laser processing of many metals, such as stainless steel, titanium and others, is frequently associated with formation of colors as a result of oxidation. For this and other reasons, the EOAT may include a gas-supplying mechanism 76 which is attached to plate 70 and provided with a gas nozzle 78. The gas nozzle 78 has a hollow interior traversed by both laser beam 68 and gas stream which are guided within the nozzle towards the outlet of nozzle 78 in a parallel and coaxial manner. This realized by mounting nozzle 78 so that it is centered on 6^{th} axis VI-VI.

Referring to FIG. 12, gas-supplying mechanism 76, like all other end effectors, may be coupled to plate 70 alone or in combination with other end effectors, such as sensor 72. Thus, as shown here, the gas-supplying mechanism with nozzle 78 is mounted together to plate 70 with wire supply mechanism 74 and sensor 72. The mounted end effectors are rotatable about 6^{th} axis VI-VI, whereas laser head assembly 40 is stationary relative this axis.

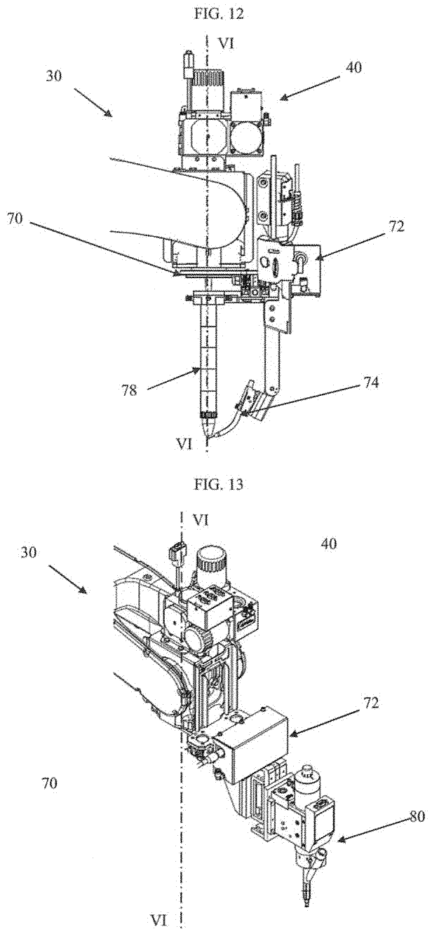

FIG. 13 illustrates another advantage of the inventive structure in which laser head assembly 40 is rotationally uncoupled from the rest of the EOAT. Frequently, laser welding alone may be insufficient or simply unnecessary for any given operation which is part of the overall process including its laser processing stage. With laser head assembly 40 rotationally disconnected from tool change 47, it is not necessary to remove the laser head from robot 30 if another type of material processing is required. For example, as illustrated here, a stud-welding assembly 80 is mounted to plate 70, while laser head assembly 40 remains intact. Basically, one end of plate 70 supports laser head assembly 40, whereas the opposite plate's end supports stud-welding assembly 80 alone or in combination with other end effectors, such as sensor 72. Stud welding is a process by which a metal stud is joined to a metal workpiece by heating both parts with an arc. Thus, although different from a laser welding technique, nothing prevents stud-welding assembly 80 from being mounted together with laser head assembly 40 on robot 30 due to the disclosed position of the laser head which is spaced apart and rotationally uncoupled from tool changer 47. If necessary, both processes the laser and stud welding—can be used simultaneously utilizing the inventive structure.

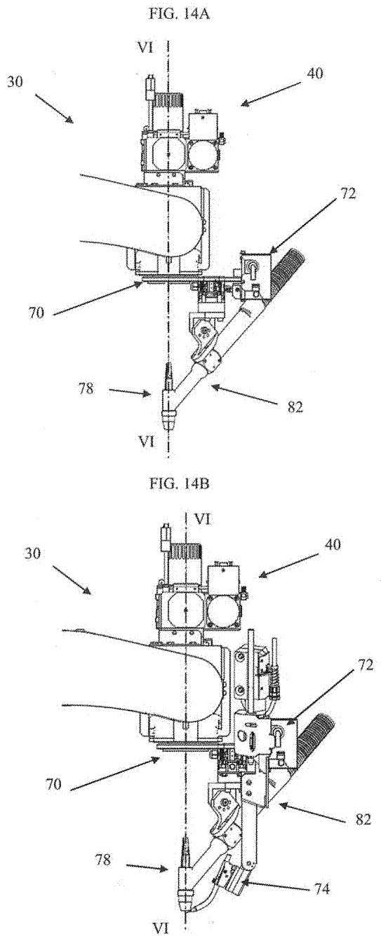

FIGS. 14A and 14B illustrate inventive robot 30 used with another alternative material processing method—Gas Tungsten Arc Welding (GTAW), also known as Tungsten Inert Gas (TIG) welding which is represented in these figures by a TIG assembly 82. The TIC method involves a tungsten electrode heating the metal to be welded. This technique is known for use of inert gases, such as argon, which shield the weld from oxygen contamination. The TIG assembly 82, which is mounted to plate 70, may be utilized alone without laser head assembly 40. However, it is not unusual to combine the TIC and laser processes together. Again, the inert gas is supplied into gas nozzle 78 as shown in FIG. 14A. In addition, FIG. 14B illustrates wire-suppling mechanism 74. This laser/TIG hybrid welding can be a faster process compared to laser and TIC welding on their own. It produces a higher seam quality. The combination of laser and TIC welding methods improve the weld's tolerance to joint fit-up.

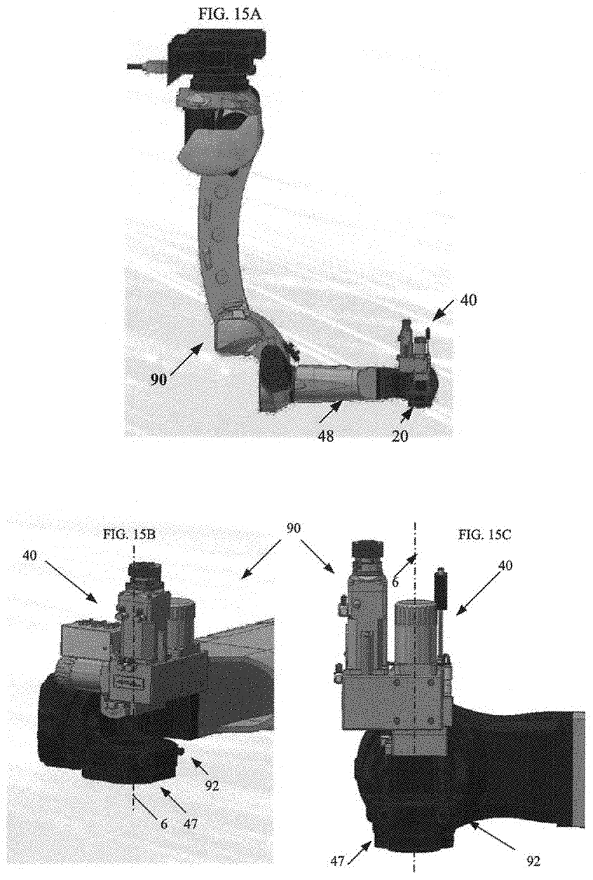

FIGS. 15A-15C illustrate another type of laser provided with a structure configured in accordance with the inventive concept. Whereas robot 30 illustrated in FIGS. 5-14 is manufactured by Yaskawa, FIGS. 15A-15C illustrate robot 90 manufactured by Fanuc. Conceptually, however, the configuration of FIGS. 15A-15C carries out the inventive concept in accordance. In particular, the tip of wrist 48 is coupled to hand 20 which supports on one end thereof laser head assembly 40 and on the other end tool changer 47. The laser head 40 is rotationally independent from tool changer 47 and is mounted on hand 20 so that it is rotationally stationary relative the last axis 6.

Referring to all FIGS. 4-15C, certain structural modifications can be introduced to a great variety of robots including, of course, shown robots 30 and 90. As disclosed above, laser head assembly 40 is mounted on one end of hand 92. However, laser head assembly 40 may be mounted to the proximal end of wrist opposite to its tip which is coupled to the hand. Such a modification, however, requires additional beam guiding optics.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

1. A multi-axis robot comprising:
a wrist having a tip,
a hollow hand coupled to the tip of the wrist such that the hand can swing about a next to last axis of the robot, the hollow hand receiving an insert of the robot, and
a laser head assembly mounted to an end of the hollow hand arm which is opposite to a workpiece such that the laser head assembly is rotationally decoupled from the insert, wherein the laser head assembly outputs the laser beam which is guided through the hollow hand so that it is incident on the workpiece.

2. The multi-axis robot according to claim 1, wherein the multi-axis robot is a 6-axis robot and wherein the next to last axis is the 5^{th} axis of the robot and the last axis is the 6^{th} axis of the robot.

3. The multi-axis robot of claim 1, wherein the laser head assembly is mounted by means of a mount to the hollow hand, wherein the mount is implemented as a part of the hollow hand and/or as an external element attached to the hollow hand and wherein the laser head assembly is uncoupled from the rotational movement about the last axis of the robotic arm.

4. The multi-axis robot of claim 1 further comprising an end-of-arm tooling (EOAT) including at least one end effector detachably mountable to the robot and wherein the at least one end effector is rotatable about the last axis of the robot.

5. The multi-axis robot of claim 4, wherein the at least one end effector is configured with at least one component selected from the group consisting of a sensor assembly, a cold wire delivery assembly gas-supplying assembly, tungsten inert gas (TIG) assembly, metal inert gas (MIG) assembly, metal arc active gas (MAG) assembly, stud welding assembly and a combination of these.

6. The multi-axis robot of claim 1, wherein the hollow hand arm having a hollow housing which receives a hollow flanged shaft rotatable about the last axis of the robot and wherein the hollow flanged shaft extends beyond an end of the mount which is opposite to an end of the mount supporting the laser head assembly.

7. The multi-axis robot of claim 6 further comprising a support plate coupled to a surface of a flange of the hollow flanged shaft which looks away from the laser head assembly and wherein the support plate is adapted to support one of or a combination of the end effectors detachably mounted to the support plate.

8. The multi-axis robot of claim 5, wherein the TIG assembly operates simultaneously with or independently from the laser head assembly.

9. The multi-axis robot of claim 5, wherein the gas-supply assembly includes a gas nozzle which is configured with a hollow interior, the laser head assembly outputting the laser beam which traverses the hollow interior of the gas nozzle.

10. The multi-axis robot of claim 3, wherein the mount includes a frame detachably coupled to the hand.

11. A multi-axis robot comprising:
a hollow hand swingable about a next to last axis;
an insert received in an interior of the hollow hand and rotatable about a last axis which extends transversely to the next to last axis; and
a laser head assembly mounted to the hollow hand so that the laser head assembly is stationary relative to the last axis, wherein the laser head assembly outputs a laser beam guided through the insert an incident on a workpiece to be irradiated.

12. The multi-axis robot of claim 11 further comprising:
a mount provided on the hollow hand and configured to support the laser head assembly so that it is coaxial with the insert but rotationally decoupled therefrom, and
a tool changer coupled to an end of the insert, which is opposite to the workpiece, the tool changer being rotatable with the insert, wherein the hollow hand includes a hollow housing and a hollow flanged shaft received within the housing and rotatable about the last axis.

13. The multi-axis robot of claim 12, wherein the tool changer is configured with a support plate coupled to the flange, and a plurality of end effectors each of which is detachably mounted to the support plate, wherein the support plate supports one of or a combination of the end effectors.

14. The multi-axis robot of claim 13, wherein the end effectors include a tool selected from the group consisting of a sensor assembly, a cold wire delivery assembly, a gas-supply assembly, a tungsten inert gas (TIG) assembly, a metal inert gas (MIG) or metal arc active gas (MAG) assembly, a stud welding assembly and a combination of these assemblies.

15. The multi-axis robot of claim 14, wherein the tungsten inert gas TIG assembly operates simultaneously with or independently from the laser head assembly while the laser head assembly is still mounted on the hollow hand.

16. The multi-axis robot of claim 14, wherein the gas-supply assembly includes a gas nozzle which is configured with a hollow interior, the laser head assembly outputting the laser beam traversing the hollow interior of the gas nozzle.

17. The multi-axes robot of claim 11 further comprising a plurality of arms coupled together to provide a 6-axis robotic structure, wherein the last axis is a 6^{th} axis.
